(19) United States
(12) Patent Application Publication
(10) Pub. No.: US 2015/0113502 A1
(43) Pub. Date: Apr. 23, 2015

(54) METHOD AND SYSTEM FOR ENCAPSULATION OF APPLICATION

(71) Applicant: OpenPeak Inc., Boca Raton, FL (US)

(72) Inventor: Christopher Michael Wade, Delray Beach, FL (US)

(21) Appl. No.: 14/205,686

(22) Filed: Mar. 12, 2014

Related U.S. Application Data
(60) Provisional application No. 61/892,584, filed on Oct. 18, 2013.

(51) Int. Cl. G06F 9/44; G06F 9/45

(52) U.S. Cl. CPC G06F 8/30; G06F 8/41
USPC 717/106; 717/140

(57) ABSTRACT

A system and method for encapsulating a target application are described herein. In particular, an analysis of the target application can be performed to determine one or more characteristics of the target application. Based on the analysis of the target application, a blueprint of the target application can be generated. Based on the blueprint, an encapsulation application can be constructed for the target application. In addition, the target application can be encapsulated with the encapsulation application to create an encapsulated target application to enable adaptive loading of the target application.

### CROSS-REFERENCE TO RELATED APPLICATIONS

This patent application claims priority to U.S. Provisional Patent Application No. 61/892,584, filed on Oct. 18, 2013, which is incorporated herein by reference in its entirety.

### FIELD OF TECHNOLOGY

The present description relates to methods and systems for the encapsulation of applications and more particularly, the encapsulation of applications for the adaptive loading of such applications.

### BACKGROUND

In an effort to increase productivity, many employers allow their workers to conduct business related to the employer on their personal mobile devices. In some cases, employers also provide some of their employees with company-issued mobile devices. In either arrangement, an employer understands that a single device may include sensitive data related to that employer in addition to data that is personal to the employee. Several advances have been made in an effort to protect an employer's data in these circumstances. For example, OpenPeak Inc. of Boca Raton, Fla. has developed solutions that enable a mobile device to include both enterprise and personal data but that isolate the enterprise data from the personal data. As part of these solutions, an employee may download secure applications that may be used to conduct transactions related to the enterprise, but these secure applications are prevented from exchanging data with conventional or non-secure applications.

These secure applications are typically altered to enable management of the applications and for security purposes, a process sometimes referred to as “wrapping” the application. In certain cases, an application is wrapped by manipulating the binary of the application and inserting code in the application to enable the interception of calls to and from the application. This process can increase the functionality of the application and can make it secure, as described above. There may be times, however, when the structure of the secure application is incompatible with the requirements of an entity that operates an application store to which the secure application is intended to be uploaded.

### SUMMARY

A method of encapsulating a target application is described herein. The method can include the step of performing an analysis of the target application to determine one or more characteristics of the target application. Based on the analysis of the target application, a blueprint of the target application can be generated. Based on the blueprint, an encapsulation application for the target application can be constructed. The method can also include the step of encapsulating the target application with the encapsulation application to create an encapsulated target application to enable adaptive loading of the target application.

In one arrangement, the encapsulation application can include a text segment and a data segment. Encapsulating the target application can include the steps of padding the text segment and the data segment of the encapsulation application and extracting a text segment and a data segment of the target application. Encapsulating the target application can also include the step of writing the text segment and the data segment of the target application in the padding of the text segment and the data segment of the encapsulation application. The method can further include the step of providing the encapsulated target application to an application repository.

The method can also include the step of identifying a starting point of the text segment and the data segment of the encapsulation application and a corresponding starting point for the text segment and the data segment of the target application. In addition, writing the text segment and the data segment of the target application may include writing the text segment and the data segment of the target application beginning at the starting point of the text segment and the data segment of the encapsulation application. Padding the text segment and the data segment of the encapsulation application may be based on the blueprint of the target application.

Another method of encapsulating an application is described herein. The method can include the step of analyzing a target application to determine one or more characteristics of the target application. Based on the analysis, an encapsulation application can be constructed. In addition, the method can include the step of encapsulating the target application with the encapsulation application to create an encapsulated target application that is configured to enable adaptive loading of the target application when the encapsulated target application is loaded into memory.

As an example, encapsulating the target application with the encapsulation applications can include reserving a portion of the encapsulation application to receive at least a portion of the target application and writing the portion of the target application into the reserved portion of the encapsulation application. As another example, reserving the portion of the encapsulation application may include padding predetermined sections of the encapsulation application. Also, writing the portion of the target application may include writing corresponding predetermined sections of the target application into the predetermined sections of the encapsulation application. The method can further include the step of receiving the target application from a developer of the target application.

A system for encapsulating a target application is also described herein. The system can include an interface that is configured to receive the target application and a linker that can be communicatively coupled to the interface. In one arrangement, the linker can include an analyzer that can be configured to analyze the target application to determine one or more characteristics of the target application and to generate a blueprint of the target application based on the analysis of the target application. The linker can also include a compiler that can be communicatively coupled to the analyzer. The compiler can be configured to construct an encapsulation application based on the blueprint of the target application and to encapsulate the target application with the encapsulation application to create an encapsulated target application. The encapsulated target application can be configured to enable adaptive loading of the target application.

In one arrangement, the compiler may be configured to encapsulate the target application with the encapsulation application by (1) identifying a portion of the encapsulation application; (2) reserving the portion of the encapsulation application for the target application; and (3) writing at least a portion of the target application into the reserved portion of the encapsulation application. In addition, the compiler may be configured to reserve the portion of the encapsulation application by writing non-functional code into the identified portions of the encapsulation application. The compiler may also be configured to write the portion of the target application by overwriting the non-functional code in the identified portions of the encapsulation application with the portion of the target application. In another arrangement, the compiler may be configured to extract data from the target application so that the compiler is able to write the portion of the target application into the reserved portion of the encapsulation application. The interface of the system may be further configured to send the encapsulated target application to an application store for eventual distribution.

Another method of encapsulating a target application is described herein. This method can include the steps of performing an analysis of the target application to determine one or more characteristics of the target application and based on the analysis of the target application and generating a blueprint for the target application. Based on the blueprint, an encapsulation application for the target application can be constructed. The method can also include the steps of encapsulating the target application with the encapsulation application to create an encapsulated target application and loading the encapsulation application in memory. Memory can be allocated for the encapsulated target application, and the encapsulated target application can be remapped into the allocated memory. Additionally, the encapsulated target application can be configured to enable the calls of the encapsulated target application to be intercepted by the encapsulation application. Each of the steps of the methods described above can be performed or facilitated by one or more processing units or other similar hardware components, including individually or working in tandem with one or more other devices or components.

A non-transitory computer readable storage medium having stored thereon computer readable program code is also described herein. The computer readable program code, when executed by a system comprising a processing unit and a memory, can cause the system to perform an analysis of a target application to determine one or more characteristics of the target application and based on the analysis, construct an encapsulation application for the target application. The computer readable program code, when executed by the system, can also cause the system to encapsulate the target application with the encapsulation application to create an encapsulated target application to enable adaptive loading of the target application.

In one example, the encapsulation application includes a text segment and a data segment. The computer readable code may further cause the system to encapsulate the target application by (1) padding the text segment and the data segment of the encapsulation application; (2) extracting a text segment and a data segment of the target application; and (3) writing the text segment and the data segment of the target application in the padding of the text segment and the data segment of the encapsulation application. The computer readable code can further cause the system to pad the text segment and the data segment of the encapsulation application based on the blueprint of the target application. In another example, the computer readable code can cause the system to pad the text segment and the data segment by appending the text segment and the data segment with non-functional code that is to be overridden with other code at a later time.

Further features and advantage, as well as the structure and operation of various embodiments, are described in detail below with reference to the accompanying drawings. It is noted that this description is not limited to the specific embodiments presented herein. Such embodiments are provided for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the subject matter described herein and, together with the description, further serve to explain the principles of such subject matter and to enable a person skilled in the relevant art(s) to make and use the subject matter.

FIG. 1 illustrates an example of a system that can encapsulate and adaptively load a target application.

FIG. 2 illustrates an example of a block diagram of a management unit for use in the system of FIG. 1.

FIG. 3 illustrates an example of a block diagram of a portable computing device for use in the system of FIG. 1.

FIG. 4 illustrates an example of a method for encapsulating and adaptively loading a target application.

FIG. 5 illustrates an exemplary representation of the encapsulation of a target application.

FIG. 6 illustrates an exemplary representation of the adaptive loading of an encapsulated target application.

Applicants expressly disclaim any rights to any third-party trademarks or copyrighted images included in the figures. Such marks and images have been included for illustrative purposes only and constitute the sole property of their respective owners.

The features and advantages of the embodiments herein will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The following detailed description refers to the accompanying drawings that illustrate exemplary embodiments; however, the scope of the present claims is not limited to these embodiments. Thus, embodiments beyond those shown in the accompanying drawings, such as modified versions of the illustrated embodiments, may nevertheless be encompassed by the present claims.

References in the specification to “one embodiment,” “an embodiment,” “an example embodiment,” “one arrangement,” “an arrangement” or the like, indicate that the embodiment or arrangement described may include a particular feature, structure, or characteristic, but every embodiment may not necessarily include the particular feature, structure, or characteristic. Moreover, such phrases are not necessarily referring to the same embodiment or arrangement. Furthermore, when a particular feature, structure, or characteristic is described in connection with an embodiment or arrangement, it is submitted that it is within the knowledge of one skilled in the art to implement such feature, structure, or characteristic in connection with other embodiments or arrangements whether or not explicitly described. The term “among,” as it is used throughout this description, should not necessarily be interpreted as requiring exchanges or interaction among three or more applications, irrespective of grammar rules. The word “a” is defined as one or more.

Several definitions that apply throughout this document will now be presented. The term “exemplary” as used herein is defined as an example or an instance of an object, apparatus, system, entity, composition, method, step or process. The term “communicatively coupled” is defined as a state in which two or more components are connected such that communication signals are able to be exchanged (directly or indirectly) between the components on a unidirectional or bidirectional (or multi-directional) manner, either wirelessly, through a wired connection or a combination of both. A “computing device” is defined as a component that includes one or more processing units and memory and that is configured to perform some process or function for a user and includes both mobile and non-mobile devices. The term “non-transitory computer readable storage medium” is defined as one or more non-transitory components that are configured to store instructions that are to be executed by one or more processing units.

An “application” is defined as a program or programs that perform one or more particular tasks on a computing device. Examples of an application include programs that may present a user interface for interaction with a user or that may run in the background of an operating environment that may not present a user interface while in the background. The term “operating system” is defined as a collection of software components that directs a computing device's operations, including controlling and scheduling the execution of other programs and managing storage, input/output and communication resources. A “processing unit” is defined as one or more components that execute sets of instructions, and the components may be disparate parts or part of a whole unit and may not necessarily be located in the same physical location. The term “memory” or “memory element” is defined as one or more components that are configured to store data, either on a temporary or persistent basis. The term “shared memory” is memory or a memory element that is accessible (directly or indirectly) by two or more applications or other processes. An “interface” is defined as a component or a group of components that enable(s) a device to communicate with one or more different devices, whether through hard-wired connections, wireless connections or a combination of both.

The term “file system” is defined as an abstraction that is used to organize, store and retrieve data. The term “secure application” is defined as an application that has been modified to restrict communications between the application and unauthorized programs or devices, restrict operation of the application based on policy, or to alter, augment or add features associated with the operation of the application. A “target application” is defined as an application that has been selected for conversion into a secure application. A “characteristic” of an application is defined as a feature, quality, property or attribute of the application, examples of which will be provided below. A “blueprint” of an application is a set of characteristics of an application. The term “encapsulation application” is defined as an application that is created for purposes of encapsulating a target application, and an “encapsulated target application” is defined as a target application that has been encapsulated by an encapsulation application. The term “encapsulate” is defined as writing or otherwise inserting at least a portion of the code of a target application into another application to enable adaptive loading of the target application. The term “adaptive loading” is defined as a process by which an encapsulation application simulates a system loader by serving as a dynamic loader for an encapsulated target application when the encapsulated target application is loaded into memory.

The term “encryption engine” is defined as a component or a group of components that encrypt data, decrypt data or encrypt and decrypt data. A “linker” is defined as a combination of hardware and software components that is configured to combine a number of files to form an executable. An “analyzer” is a combination of hardware and software components that is configured to analyze a target application to determine the characteristics of the target application. A “compiler” is defined as a combination of hardware and software components that is configured to construct encapsulation applications and to encapsulate target application with the encapsulation application, as described herein, including through any necessary language translations.

As explained earlier, solutions have been developed to enable employees of an enterprise to carry mobile devices that include both enterprise and personal data, with the enterprise data being isolated from the personal data. As part of these solutions, one or more secure applications may be installed on an employee's mobile device. Ensuring that these secure applications are compatible with various formats is an issue that must be resolved.

As part of this resolution, a system and method for encapsulating a target application are presented herein. In particular, an analysis of the target application can be performed to determine one or more characteristics of the target application. Based on the analysis of the target application, a blueprint of the target application can be generated. Based on the blueprint, an encapsulation application can be constructed for the target application. In addition, the target application can be encapsulated with the encapsulation application to create an encapsulated target application to enable adaptive loading of the target application.

Through adaptive loading, the target application may be managed and controlled like a conventional or typical wrapped application. The target application, however, may be compatible with the various requirements for installation into certain application stores. As such, secure applications can be easily generated and distributed through the normal channels for doing so.

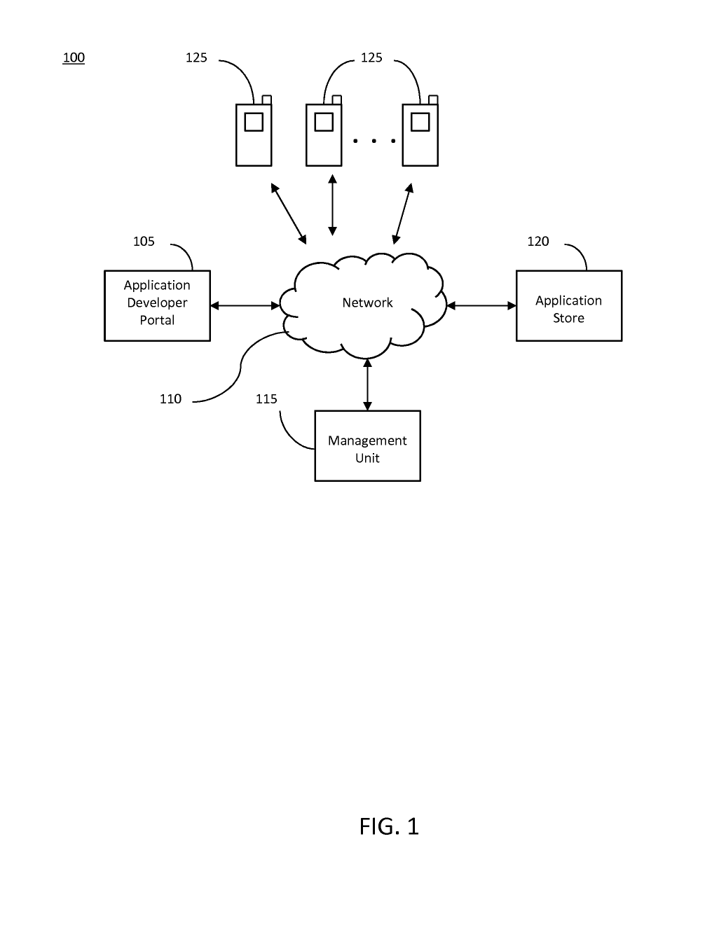

Referring to FIG. 1, a system 100 for encapsulating and adaptively loading a target application is shown. In one arrangement, the system 100 can include an application developer portal 105, a network 110, a management unit 115, an application store or repository 120 and any number of portable computing devices 125. Although not shown here, the system 100 can include multiple application developer portals 105, networks 110, management units 115 or application stores 120. Also, while the system 100 references a portable computing device, the system 100 and the processes described herein may be relevant to and practiced with fixed computing devices.

The application developer portal 105 can present an interface that enables developers of applications to upload their applications for eventual publication in the application store 120. The application store 120, as is known in the art, can enable users of the portable computing devices 125 to install such published applications on their devices 125. In some cases, the applications from the application developers may be directed to the management unit 115 prior to being published in the application store 120. Through the management unit 115, the applications may be modified such that they are more conducive for operation on behalf of an enterprise or other organization. For example, the applications may be converted into secure or wrapped applications, a process in which certain functions of the application may be restricted or enhanced, depending on input from the enterprise. Examples of this process are known in the art, and additional information may be obtained from U.S. patent application Ser. No. 13/626,470, filed on Sep. 25, 2012, and U.S. patent application Ser. No. 14/036,415, filed on Sep. 25, 2013, each of which is herein incorporated by reference in its entirety.

Once a secure application is generated, it can be published in the application store 120, similar to a conventional application that has been published. An application that has been selected for conversion into a secure application by the management unit 115 (or some other component) may be referred to as a target application.

The network 110 can facilitate communications between any of the components of the system 100. As mentioned earlier, there may be multiple networks 110 in the system 100, and each network 110 may be composed of various types of components to support wireless or wired communications (including both). In addition, the network(s) 110 may be configured to support both local or wide area communications (or both).

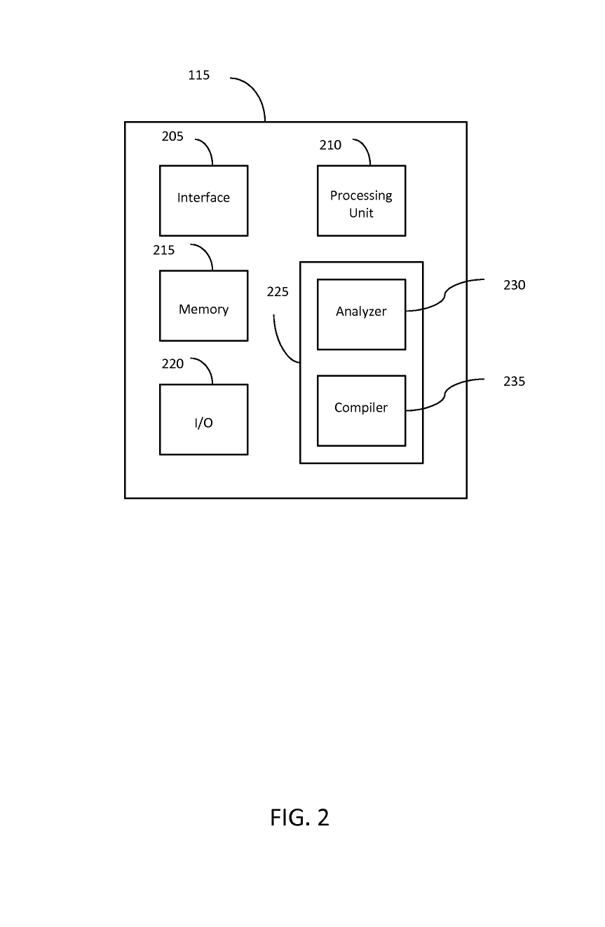

Referring to FIG. 2, an exemplary block diagram of the management unit 115 of FIG. 1 is shown. As mentioned earlier, the management unit 115 can be useful in creating secure applications for publication in the application store 120 of FIG. 1. In one arrangement, the management unit 115 can include one or more interfaces 205, one or more processing units 210, one or more memory elements 215, one or more input/output (I/O) elements 220 and one or more linkers 225. The linker 225 can include one or more analyzers 230 and one or more compilers 235, although in another arrangement, the analyzer 230 and/or the compiler 235 may be separate components from the linker 225 or may be integrated with some other suitable component.

The interface 205 can be configured to receive target applications from the application developer portal 105 or from other appropriate sources. The memory 215 can include persistent or non-persistent memory (or both), which can be useful for storing programs and other instructions for carrying out the processes described herein. The I/O element 220 can include any suitable device that enables a human or machine to provide input to or receive output from the management unit 115. The linker 225, the analyzer 230 and the compiler 235 can be comprised of any suitable combination of hardware and software to facilitate the encapsulation of target applications and the adaptive loading of such applications. For example, the analyzer 230 can be configured to analyze the incoming target applications to determine their characteristics, and this information can be used by the compiler to construct an encapsulation application to encapsulate the target application. Additional description of this process will be presented below.

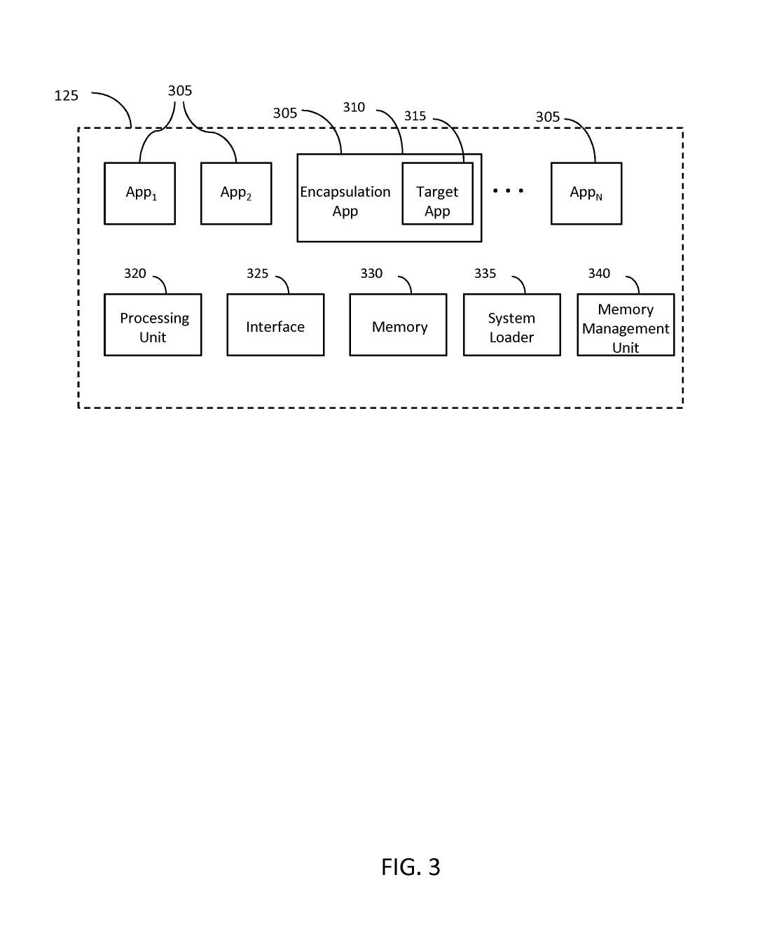

Referring to FIG. 3, an exemplary block diagram of a portable computing device 125 is shown. In one arrangement, the portable computing device 125 can access the application store 120 (see FIG. 1) and can download and install one or more applications 305, at least some of which may be secure applications. In addition, the device 125 can download an encapsulation application 310, which may be considered a secure application, from the application store 120 and install the encapsulation application 310. The encapsulation application 310, as mentioned earlier, can encapsulate a target application 315. By encapsulating the target application 315, the target application 315 can be written into the encapsulation application 310, and the encapsulation application 310 can facilitate the loading of the target application 310 in the device 125 at runtime.

The portable computing device 125 can also include one or more processing units 320, one or more interfaces 325, one or more memory elements 330, one or more system loaders 335, and one or more memory management units 340. As is known in the art, the device 125 may also include one or more abstraction layers that include system interfaces and that facilitate operation of the applications 305 and other functions of the device 125. As is also known in the art, the device 125 can include a kernel (not shown), which provides interfaces for the abstraction layers to interact with any suitable number and type of hardware components.

The processing unit 320 can be communicatively coupled to any number of the components of the device 125 and may be responsible for controlling or directing their operations. In one arrangement, the interface 325 can be configured to enable communications between the computing device 125 and any external devices or networks, such as the network 110. In particular, the interface 325 can support wired or wireless communications, over local or wide area networks. Through this interface 325, the portable computing device 125 can download the applications 305, including the encapsulation applications 310 that have encapsulated the target applications 315. As there are many different forms of communications and protocols, the computing device 125 can include any suitable number of interfaces 325.

The memory element 330 may be accessible by the applications 305 and other components of the computing device 125. The memory element 330 may be a combination of memory components and may include both persistent and non-persistent types. In addition, the memory element 330 and other components of the computing device 125 may be configured to support virtual memory, which can increase the efficiency of the device 125. As is known in the art, the system loader 335 can be any suitable combination of hardware and software to enable the loading and execution of any of the applications 305 installed on the device 125, include the encapsulation application 310. As will be explained below, the encapsulation application 310 can be configured to simulate the system loader 335 to enable the runtime execution of the target application 315. The memory management unit 340 can manage the memory element 330 in accordance with well-known principles. The foregoing listing of components with respect to the portable computing device 125 is not meant to be exhaustive, as the device 125 may include any suitable number and type of such components, including even fewer than are pictured here.

In one example, the portable computing device 125 may be a managed device, which enables a party to control certain aspects of the device 125, including the type of content that may be delivered to the device 125. Earlier presentations have been provided that illustrate a solution that describes some of these techniques, such as in U.S. patent application Ser. No. 13/179,513, filed on Jul. 9, 2011, which is incorporated by reference herein in its entirety. It is not necessary, however, for the device 125 to be a managed device to practice the processes described herein.

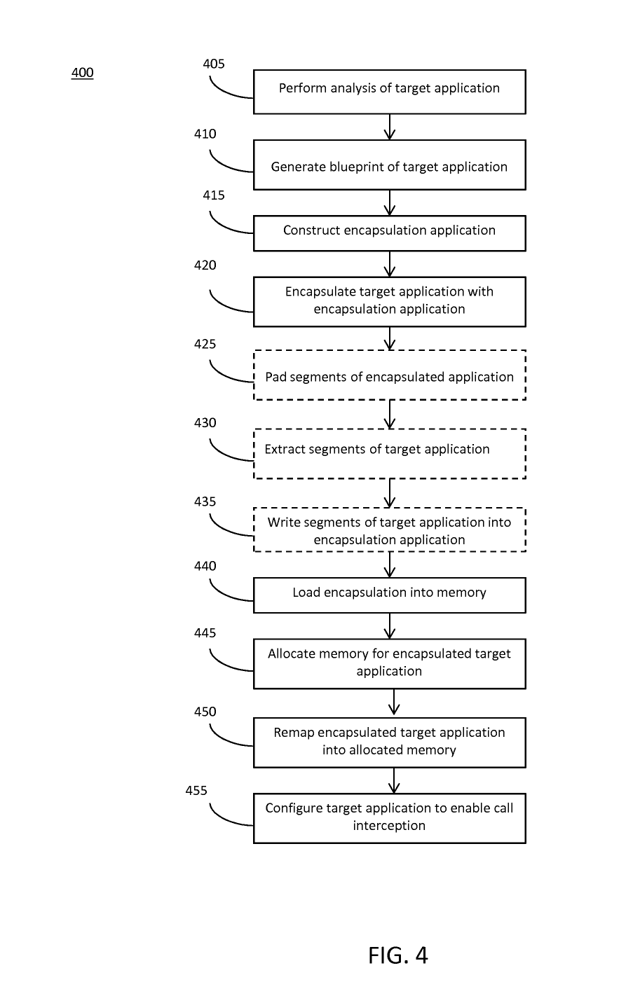

Referring to FIG. 4, an exemplary method 400 for encapsulating a target application and adaptively loading that application is illustrated. It is important to note, however, that the method 400 may include additional or even fewer steps or processes in comparison to what is illustrated in FIG. 4. Moreover, the method 400 is not necessarily limited to the chronological order that is shown in FIG. 4. In describing the method 400, reference may be made to FIGS. 1-3, 5, and 6, although it is understood that the method 400 may be practiced with any other suitable systems and components and may take advantage of other suitable processes.

At step 405, an analysis of a target application can be performed to determine one or more characteristics of the target application. At step 410, based on the analysis of the target application, a blueprint of the target application can be generated. At step 415, based on the blueprint, an encapsulation application can be constructed for the target application. The target application can be encapsulated with the encapsulation application, which can create an encapsulated target application to enable adaptive loading of the target application, as shown at step 420.

Steps 425-435 present one example of how the target application can be encapsulated by the encapsulation application. In particular, at step 425, segments or portions of the encapsulation application can be padded, and segments or portions of the target application can be extracted, as shown at step 430. As an example, the portions of the target application that are extracted can correspond to the portions of the encapsulation application that are padded. At step 435, the extracted segments of the target application can be written into the padding of the encapsulation application.

Examples of the steps of FIG. 4 presented above thus far will now be illustrated. In one arrangement, a target application 315 can be received at the management unit 115, and the target application 315 can be directed to the linker 225 (see FIG. 2). At the linker 225, the analyzer 230 can analyze the target application 315 to determine certain characteristics of the target application 315. The characteristics of the target application 315 may be parameters that are related to its loading and execution. For example, information can be obtained from the header, the load commands, and the section headers of the target application 315, such as the architecture, layout and linkage characteristics and memory requirements of the target application 315. Additional data can be gleaned from the link edit segment of the application 315, such as the symbol, string, and relocation tables.

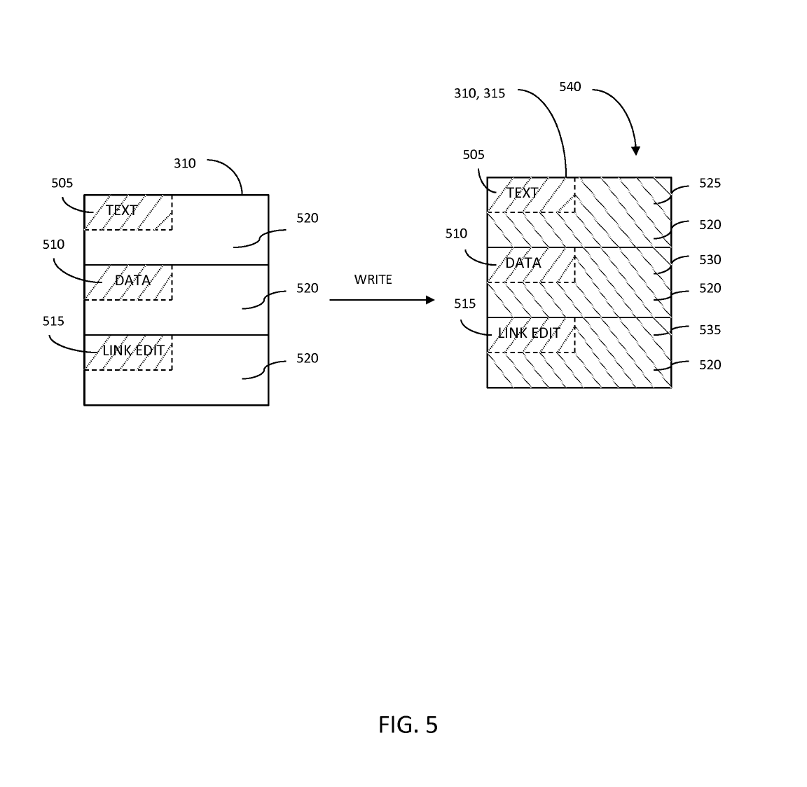

Based on this analysis, the analyzer 230 can generate a blueprint of the target application 315. The blueprint can include the information associated with the analysis of the target application 315, and the compiler 235 can construct the encapsulation application 310 based on this blueprint. Referring to FIG. 5, an example of an encapsulation application 310 is shown on the left side of the drawing. The encapsulation application 310 can include many or all the conventional parts of an application, such as a header, load commands, and text, data, and link edit segments, as well as other segments. Moreover, the encapsulation application 310 can include code that enables the allocation and loading of a target application 315, in addition to the management and control of the target application 315. For simplicity, only a text segment 505, a data segment 510 and a link edit segment 515 of the encapsulation application 310 are shown, although those skilled in the art will appreciate that the encapsulation application 310 can include the sections described above. The diagonal lines (running from lower left to upper right) in the text, data and link edit segments 505, 510, 515 represent the code of the encapsulation application 310. This code can include instructions on adaptively loading the target application 315, as well as information on managing or controlling the target application 315 once the target application 315 is loaded.

Once the encapsulation application 310 is constructed, the linker 225 can locate certain symbols in the segments of the encapsulation application 310 and can open the binary of the encapsulation application 310. The linker 225 can also extract the data from the target application 315. For example, the linker 225 can identify an app start symbol in the sections of the encapsulation application 310 and can extract the corresponding sections of the target application 315. To accommodate the data from the target application 315, the linker 225 can pad or grow the original sections of the encapsulation application 315. For example, as shown in FIG. 5, the linker 225 can increase the size of the text, data, and link edit segments 505, 510, 515 of the encapsulation application 310 by appending these segments with padding 520, or non-functional code that can be overridden with other code at a later time. The amount of space necessary for such a process can be obtained from the blueprint of the target application 315, as referenced above.

The linker 225 can then write the relevant sections of the target application 315 into, for example, the padding 520 of the corresponding sections of the encapsulation application 310, starting at the relevant start symbol of these sections. An example of this process is shown in FIG. 5 on the right side of the drawing in which a text segment 525, a data segment 530, and a link edit segment 535 of the target application 310 are written into the padding 520 of the encapsulation application 310. The diagonal lines running from the upper left to the lower right represent the code of the target application 315. Although only a portion of the overall sections of the encapsulation application 310 and the target application 315 are shown in FIG. 5, this process can also be extended to other portions of the encapsulation application 310. For example, the header or the load commands of the target application 315 can be written into corresponding portions of the encapsulation application 310. In fact, the entire target application 315 can be written into the encapsulation application 310 in this fashion to enable the operation of the target application 315 when it is extracted from the encapsulation application 310 and executed.

When the target application 315 is written into the encapsulation application 310, it can be referred to as an encapsulated target application 540. As will be explained below, this process can enable adaptive loading of the target application 315. The encapsulated target application 540 can then be delivered to the application store 120 or some other component by the management unit 115 or some other device. Eventually, the encapsulated target application 540 can be installed on the portable computing device 125.

Referring back to FIG. 4, at step 440, an encapsulation application can be loaded into memory in which the encapsulation application encapsulates a target application. At step 445, memory can be allocated for the encapsulated target application, and the encapsulated target application can be remapped into the allocated memory such that the target application is loaded in the memory, as shown at step 450. At step 455, the target application can be configured to enable calls of the target application to be intercepted by the encapsulation application.

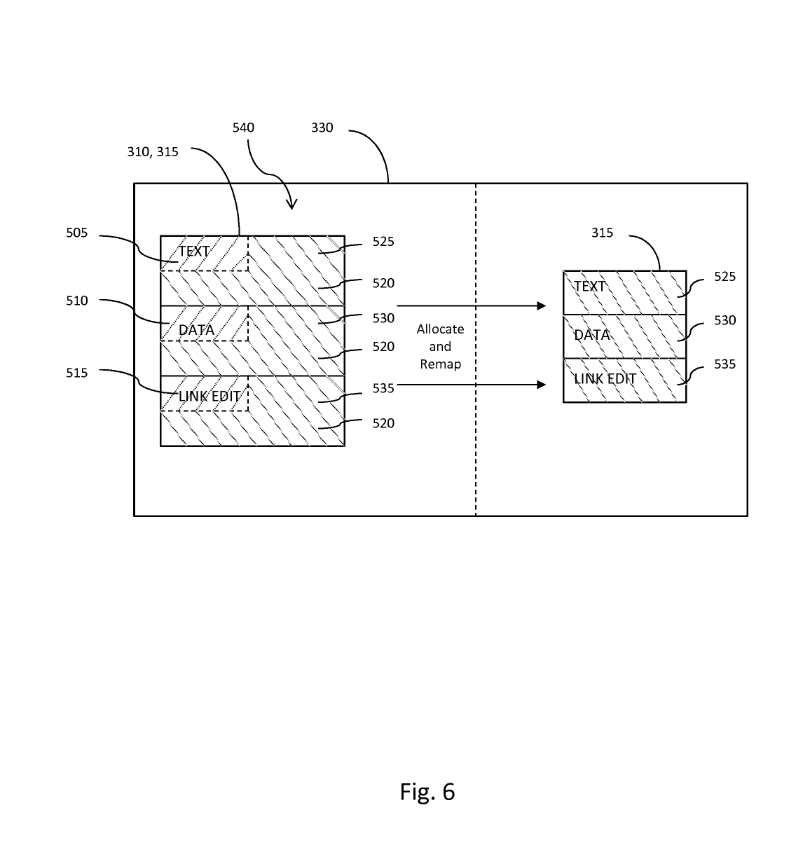

Examples of the remaining steps of FIG. 4 presented above will now be illustrated. In one example, the encapsulated target application 540 can be installed on the portable computing device 125. Referring to FIG. 6, an example of the encapsulated target application 540 loaded in the memory 330 of the device 125 is shown. As noted earlier, the target application 315 has been written into the encapsulation application 310.

When the encapsulation application 310 is loaded into the memory 330, the system loader 335 of the device 125 can access the relevant sections of the encapsulation application 310 to facilitate this process. For example, the system loader 335 can parse the encapsulation application 310 and can load the application 310 as it would for a conventional application 305 installed on the portable computing device 125.

Once the encapsulation application 310 is loaded in the memory 330, the system loader 335 can hand off control to the encapsulation application 310. In turn, the encapsulation application 310 can simulate the operation of the system loader 335 by facilitating the loading of the target application 315 that has been encapsulated into the memory 330. That is, the encapsulation application 310 can adaptively load the target application 310. A representation of this process is shown in FIG. 6.

In one arrangement, the encapsulation application 310, in conjunction with the memory management unit 340, can allocate memory for the target application 315 that has been encapsulated and can remap the target application 315 into the memory 330. For efficiency, the remap of the target application can involve a virtual memory remap. Through this process, the original target application 315 can be constructed in the memory 330. That is, the original code of the target application 315 can be remapped to another part of the memory 330, which is shown on the right side of the drawing of FIG. 6. To support this process, the target application 315 can include position-independent code.

Thus, as reflected in FIG. 6, the encapsulation application 310 is loaded into the memory 330 and can act as a dynamic loader to enable the loading of the target application 315 in another portion of the memory 330. The encapsulation application 310 can accomplish this process by parsing the target application 315 and performing the tasks that the system loader 335 would normally carry out, like symbol resolution and class creation. At this point, the target application 315 can operate as it normally would, although the encapsulation application 310 may be configured to manage or control such operation, as will be described below. In addition, even though there are two separate binaries loaded in the memory 330, one of which is loaded by the other, the overall combination is considered a single process, at least to the operating system of the portable computing device 125. As a result, the target application 315 and the encapsulation application 310 can easily make calls to one another.

As part of the loading process, the encapsulation application 310 can configure the target application 315 to enable the encapsulation application 310 to intercept the calls of the target application 310. For example, the encapsulation application 310 can determine one or more entry points of the target application 315 and can modify the entry point of the target application 315 to cause it to point back to an entry point of the encapsulation application 310. As such, when the target application 315 is executed, the process can point to an override entry point in the encapsulation application 310, and the code of the encapsulation application 310 can be executed.

As part of this execution, one or more calls associated with the target application 315 can be hooked by the encapsulation application 310, thereby enabling these calls to be intercepted. The calls can be related to virtually any function or feature of the target application 315, including I/O calls and socket calls. Once completed, the process can jump back to the original entry point of the target application 315. At this point, the target application 315 may execute as it normally would, but its functions have been hooked. For example, if the target application 315 generates a call to write data to a certain location, because the call is hooked, the data may be encrypted prior to being written, a feature that may have not been available on the target application 315 as originally constructed. As referenced earlier, this technique is facilitated by the encapsulation application 310 and the target application 315 being part of the same process space. Moreover, the target application 315, because it is under the control of or at least being managed by the encapsulation application 310, may be a secure application. Additional information on the interception of calls from a secure application can be found in the '470 patent application, referenced above.

While various embodiments have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

What is claimed is:

1. A method of encapsulating a target application, comprising:
performing an analysis of the target application to determine one or more characteristics of the target application;
based on the analysis of the target application, generating a blueprint of the target application;
based on the blueprint, constructing an encapsulation application for the target application; and
encapsulating the target application with the encapsulation application to create an encapsulated target application to enable adaptive loading of the target application.

2. The method according to claim 1, wherein the encapsulation application includes a text segment and a data segment, and encapsulating the target application comprises:
padding the text segment and the data segment of the encapsulation application;
extracting a text segment and a data segment of the target application; and
writing the text segment and the data segment of the target application in the padding of the text segment and the data segment of the encapsulation application.

3. The method according to claim 2, further comprising identifying a starting point of the text segment and the data segment of the encapsulation application and a corresponding starting point for the text segment and the data segment of the target application.

4. The method according to claim 3, wherein writing the text segment and the data segment of the target application comprises writing the text segment and the data segment of the target application beginning at the starting point of the text segment and the data segment of the encapsulation application.

5. The method according to claim 2, wherein padding the text segment and the data segment of the encapsulation application is based on the blueprint of the target application.

6. The method according to claim 1, further comprising providing the encapsulated target application to an application repository.

7. A method of encapsulating an application, comprising:
analyzing a target application to determine one or more characteristics of the target application;
based on the analysis, constructing an encapsulation application; and
encapsulating the target application with the encapsulation application to create an encapsulated target application that is configured to enable adaptive loading of the target application when the encapsulated target application is loaded into memory.

8. The method according to claim 7, wherein encapsulating the target application with the encapsulation applications comprises:
reserving a portion of the encapsulation application to receive at least a portion of the target application; and
writing the portion of the target application into the reserved portion of the encapsulation application.

9. The method according to claim 8, wherein reserving the portion of the encapsulation application comprises padding predetermined sections of the encapsulation application and writing the portion of the target application comprises writing corresponding predetermined sections of the target application into the predetermined sections of the encapsulation application.

10. The method according to claim 7, further comprising receiving the target application from a developer of the target application.

11. A system for encapsulating a target application, comprising:
an interface that is configured to receive the target application; and
a linker, wherein the linker is communicatively coupled to the interface and the linker comprises:
an analyzer that is configured to analyze the target application to determine one or more characteristics of the target application and to generate a blueprint of the target application based on the analysis of the target application; and
a compiler, wherein the compiler is communicatively coupled to the analyzer and the compiler is configured to construct an encapsulation application based on the blueprint of the target application and to encapsulate the target application with the encapsulation application to create an encapsulated target application, wherein the encapsulated target application is configured to enable adaptive loading of the target application.

12. The system according to claim 11, wherein the compiler is configured to encapsulate the target application with the encapsulation application by:
identifying a portion of the encapsulation application;
reserving the portion of the encapsulation application for the target application; and
writing at least a portion of the target application into the reserved portion of the encapsulation application.

13. The system according to claim 12, wherein the compiler is configured to reserve the portion of the encapsulation application by writing non-functional code into the identified portions of the encapsulation application.

14. The system according to claim 13, wherein the compiler is configured to write the portion of the target application by overwriting the non-functional code in the identified portions of the encapsulation application with the portion of the target application.

15. The system according to claim 12, wherein the compiler is further configured to extract data from the target application so that the compiler is able to write the portion of the target application into the reserved portion of the encapsulation application.

16. The system according to claim 12, wherein the interface is further configured to send the encapsulated target application to an application store for eventual distribution.

17. A non-transitory computer readable storage medium having stored thereon computer readable program code that when executed by a system comprising a processing unit and a memory, causes the system to:
perform an analysis of a target application to determine one or more characteristics of the target application;
based on the analysis, construct an encapsulation application for the target application; and
encapsulate the target application with the encapsulation application to create an encapsulated target application to enable adaptive loading of the target application.

18. The non-transitory computer readable storage medium of claim 17, wherein the encapsulation application includes a text segment and a data segment and wherein the computer readable code further causes the system to encapsulate the target application by:
padding the text segment and the data segment of the encapsulation application;
extracting a text segment and a data segment of the target application; and
writing the text segment and the data segment of the target application in the padding of the text segment and the data segment of the encapsulation application.

19. The non-transitory computer readable storage medium of claim 18, wherein the computer readable code further causes the system to pad the text segment and the data segment of the encapsulation application based on the blueprint of the target application.

20. The non-transitory computer readable storage medium of claim 18, wherein the computer readable code further causes the system to pad the text segment and the data segment by appending the text segment and the data segment with non-functional code that is to be overridden with other code at a later time.
